(19) United States
(12) Patent Application Publication
(10) Pub. No.: US 2015/0310435 A1
(43) Pub. Date: Oct. 29, 2015

(54) A SYSTEM AND A METHOD FOR PROCESSING A USER REQUEST USING AT LEAST ONE OF A PLURALITY OF USER INSTRUMENTS TO CONDUCT A PECUNIARY COMMUNICATION

(71) Applicant: Vikas Bhagchand CHOUDHARY, (US)

(72) Inventor: Vikas Bhagchand CHOUDHARY, Mumbai, Maharashtra (IN)

(21) Appl. No.: 14/443,386

(22) PCT Filed: Nov. 19, 2013
(86) PCT No.: PCT/IN2013/000704

§ 371 Date: May 17, 2015

(30) Foreign Application Priority Data
Nov. 19, 2012 (IN) 2558/MUM/2012

(51) Int. Cl. G06Q 20/40

(52) U.S. Cl. CPC G06Q 20/40

(57) ABSTRACT

A system and a method for processing a user request using one of a plurality of user instruments to conduct a pecuniary communication at a server with a merchant over a communications network. The system comprising a server including a content management unit configured for receiving the user request, the user request includes an OTP, a user instrument details, a merchant ID, and the pecuniary particulars. The system further comprises an authentication unit included in the content management unit for authenticating the user to conduct the pecuniary communication with the merchant by verifying the user based on the received OTP and the user instrument details and a verification unit included in the content management unit for verifying the merchant, verifying account information of the user stored at the server based on the pecuniary particulars.

### FIELD OF INVENTION

The present invention generally relates to pecuniary systems. More particularly, the invention relates to a system and method for processing a user request using one of a plurality of user instruments to conduct a pecuniary communication.

### BACKGROUND OF THE INVENTION

With the advent of debit/credit card, purchasing of goods and services is much simpler.

Now a day's customers who intend to purchase goods can do so by just carrying their credit/debit cards to the respective merchants. Once purchase of goods is completed, a merchant will swipe the card at a concurrent or synchronized device like a point of Sale (POS) device, thus completing the transaction.

The aforesaid transaction mechanism is well known in the art. The present mechanisms have a few advantages but they also come with some disadvantages.

The POS for example, includes hardware like a computer, a clear display, a keyboard and mouse for data input. Other hardware of POS consists of a barcode scanner, a credit and debit card reader, and a printer capable of printing receipts and labels. The POS device should also have the capacity to perform a secure transaction by protecting the confidential information of the credit/debit card owner like passwords and other private information.

Installation of POS devices is expensive, not all merchants can afford installing the device in places where transaction is involved.

Further, there may be cases of the POS devices not functioning properly due to wear and tear of the device. The cost of repairing the worn out POS device is expensive. Therefore, neither the customer nor the merchant can entirely depend on the credit/debit card transactions.

Most of the POS devices work on the principle that, for every swipe of the credit/debit card a corresponding deduction in the balance of the owner of the card happens. Intentionally or by mistake, the merchant may swipe the said card more than once for a single purchase in the POS device. The said action may result in a greater amount deduction than the quantity of goods purchased by the owner of the card. This act of fraud or mistake caused by the merchant may go unrecognized, which may be difficult to resolve at a later stage.

While carrying out the aforesaid mode of purchasing goods, the POS device needs to be registered to an authentication server, only then can the POS device function. As a result, the POS device has to be constantly connected to internet for connecting to different servers like the authentication server for authenticating the users.

Therefore there is a need for a system and method for managing/processing a user request for a pecuniary communication which overcomes the above mentioned drawbacks.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1A illustrates a system configured for processing a user request using at least two of a plurality of user instruments to conduct a pecuniary communication in accordance with an embodiment of the present invention.

FIG. 1B illustrates a system configured for processing a user request using at least one of a plurality of user instruments to conduct a pecuniary communication in accordance with an embodiment of the present invention.

FIG. 2 illustrates a method for processing a user request using at least one of a plurality of user instruments to conduct a pecuniary communication in accordance with an embodiment of the present invention.

### SUMMARY OF THE INVENTION

Accordingly, the invention provides a method for processing a user request using at least one of a plurality of user instruments to conduct a pecuniary communication at a server with a merchant over a communications network. The method comprising receiving a first request from the user at the user instrument in order to generate an OTP; receiving a second request at the server from the user, the second request includes the generated OTP, an user instrument details, a merchant ID, and the pecuniary particulars; verifying the user based on the received OTP and the user instrument details in order to authenticate the user to conduct the pecuniary communication with the merchant; verifying account information of the user stored at the server based on the pecuniary particulars; verifying the merchant by the server using merchant ID; and sending a confirmation message about success of the pecuniary communication to both the user and the merchant.

In another aspect, the invention provides a system for processing a user request using at least one of a plurality of user instruments to conduct a pecuniary communication at a server with a merchant over a communications network, the system comprising the user instrument generating a onetime password OTP by processing a first request signal received from a user; a server including a content management unit configured for receiving a second request, the second request includes the generated OTP, an user instrument details, a merchant ID, and the pecuniary particulars; an authentication unit included in the content management unit for authenticating the user to conduct the pecuniary communication with, the merchant by verifying the user based on the received OTP and the user instrument details; and a verification unit included in the content management unit for verifying the merchant, verifying account information of the user stored at the server based on the pecuniary particulars and thereby enabling the server to send a confirmation message about the success of the pecuniary communication to both the user and the merchant.

### DETAILED DESCRIPTION OF THE INVENTION

Various embodiments of the invention provides a system and a method for processing a user request using one of a plurality of user instruments to conduct a pecuniary communication at a server with a merchant over a communications network. Advantageously, the present invention obviates the need of concurrent/synchronized device like POS devices at merchant site.

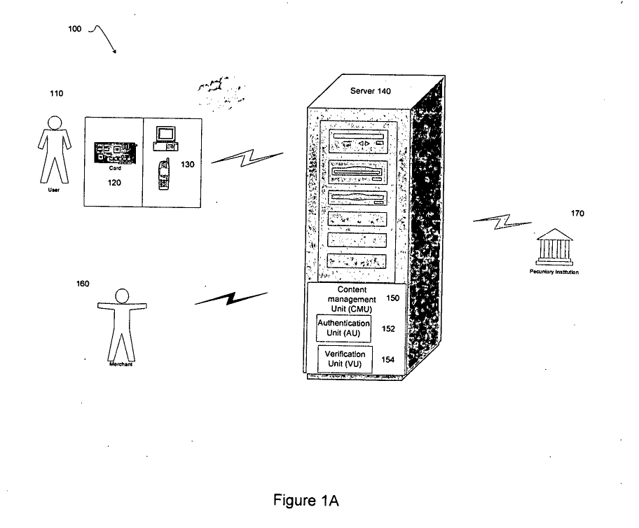

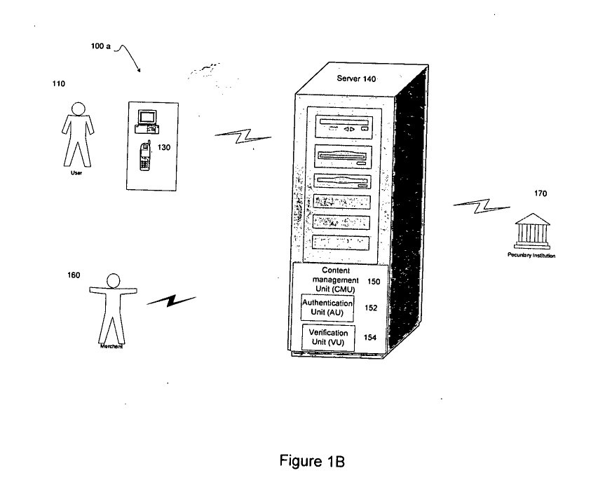

With reference to FIG. 1A of an embodiment of the invention, a system 100 the invention provides a system for processing a user request using at least one of a plurality of user instruments to conduct a pecuniary communication at a server with a merchant over a communications network. The system 100 includes the user instrument 120 generating a onetime password OTP by processing a first request signal received from a user. The user instrument 130 sending a second request signal, a server 140 including a content management unit 150 configured for receiving a second request, the second request includes the generated OTP, an user instrument details, a merchant ID, and the pecuniary particulars. The system 100 further having an authentication unit 152 included in the content management unit 150 for authenticating the user 110 to conduct the pecuniary communication with the merchant 160 by verifying the user 110 based on the received OTP and the user instrument details; and a verification unit 154 included in the content management unit 150 for verifying the merchant 160, verifying account information of the user 110 stored at the server 140 based on the pecuniary particulars and thereby enabling the server to send a confirmation message about success of the pecuniary communication to both the user 110 and the merchant 160.

In an embodiment, one of the plurality of user instrument (120, 130) includes a cash card (120) having a plurality of input keys and a Liquid Crystal Display (LCD) for displaying the OTP.

In an embodiment, one of the plurality of user instruments includes a communication device (130) like a mobile unit, PDA, tab, desktop, laptop or the like.

In an embodiment, the system 100a as shown in FIG. 1B provides generation of OTP without requiring the card 120 as the OTP is generated by the application within the user instrument 130.

In an embodiment, the pecuniary communication is initiated without requiring a concurrent/synchronized device for processing like a POS terminal.

In an embodiment the content management unit 150 enables pecuniary communication by managing communication from the authentication unit 152 and the verification unit 154 which function on different protocols.

In an embodiment, the content management unit (CMU) 150 includes information of the users.

In an embodiment the communication network is configured to interconnect various devices.

In an embodiment the communication network includes any number of wired and/or wireless networks including internet, intranet, local area networks, metropolitan networks, personal area networks, wide area networks, and direct connections.

In an embodiment the content management unit 150 is configured for verifying account information of the user with a pecuniary institution 170 through a pecuniary settlement manager.

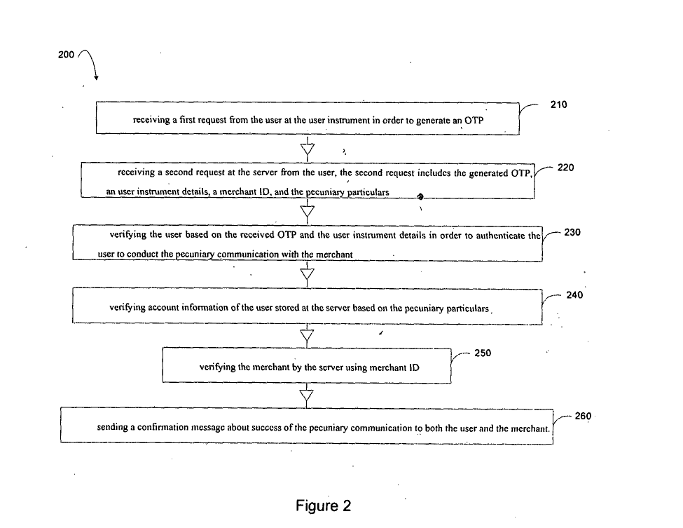

In an embodiment the present invention provides a method for processing a user request using at least one of a plurality of user instruments to conduct a pecuniary communication at a server with a merchant over a communications network as shown in the Flowchart 200 of FIG. 2.

The method comprising the step S210 of receiving a first request from the user at the user instrument in order to generate an OTP. The OTP refers to a secret word, string of characters, personal identification number (PIN), and/or password that is used for authentication which is valid for a limited amount of time for only one login session and/or transaction and is used to validate identity and/or allow access to a particular resource. Thus, an OTP would be valid for a short period of time, such as one minute. The request received at the server may be initiated from the communication device having an application which is synchronized with the server for generating OTP or it may be a standalone device which is capable of displaying OTP or it may also be any user instrument (example: Credit Card) which is having a display for displaying OTP. The credit card which is issued by the bank and synced with the server, the user generated OTP is decoded by the server. The “communication device” may be refer to any mobile and/or handheld device capable of receiving content, such as text, audio, images and/or video, in the form of an electronic signal. In addition to a smart phone, a “communication device” may also include a computer and/or computing platform, such as a laptop, tablet, personal computer and/or workstation having wireless capability connected to the Internet and/or an intranet. In S220 receiving a second request at the server from the user, the second request includes the generated OTP, an user instrument details, a merchant ID, and the pecuniary particulars. In an example embodiment, the second request initiated from the user includes the generated OTP which is generated by the user using any one of the user instrument. Moreover, the user sends the user instrument details. In an example embodiment, the user instrument details may be embedded with the generated OTP, the user instrument may be a credit card which is issued by the bank in conjunction with the server. Further, the second request also includes the merchant ID, where the merchant ID is retrieved by the user from the merchant for conducting a pecuniary communication. The merchant ID may be or may include a simple text code (for example: “ABEISD” or “785349324” or any unique identification code assigned to the merchant who is also registered with the server and further in connection with any bank, where the merchant is having the account). The pecuniary particulars is an amount in any currency for a particular article, where the user has shown interest in buying that article. In S230 verifying the user based on the received OTP and the user instrument details in order to authenticate the user to conduct the pecuniary communication with the merchant. Upon verification of the user, the server is capable of checking the user account information, whether the user is eligible for authentication. The eligibility is determined by checking whether the user has any or related amount which he/she has requested to conduct a pecuniary communication. In other way, the server compares the requested pecuniary particulars with the amount in the account. In S240 verifying account information of the user stored at the server based on the pecuniary particulars. If the user has greater amount than the requested pecuniary details, the user is verified by the server to conduct the pecuniary communication. In S250 verifying the merchant by the server using merchant ID, where the merchant ID may be a simple text or simple bar code or any other information which is unique ID assigned to the merchant. S260 sending a confirmation message about success of the pecuniary communication to both the user and the merchant. Upon successful completion of the communication, both the user and the merchant will get a confirmation message about the success of the pecuniary communication via SMS.

In an embodiment, the method further comprises the step of registering a plurality of users and a plurality of merchants with the server to avail the services of secure pecuniary communications.

In an embodiment, generating the OTP is from the user instrument having an application configured for receiving a pin and generating a corresponding OTP.

In an embodiment, the step of receiving the second request is from the user instrument, where the user sends the request including the generated OTP and the user instrument information to the server.

In an embodiment, the generated OTP is transmitted by different modes including text messaging, calling or using pre-existing application present in the user device.

In an embodiment, the confirmation message is sent by means of a text message to the user and the merchant by the server.

In an embodiment, the step of verifying the user includes verifying the user based on the received OTP and the user instrument details in order to authenticate the user to conduct the pecuniary communication with the merchant.

In an embodiment, the second request signal includes a merchant ID, an amount of goods purchased and the OTP in accordance to an embodiment of the invention.

With reference to FIGS. 1A and 1B of an embodiment of the invention, content management unit 150 interfaces with authentication unit 152, verification unit 154, the user 110 and the merchant 160 with regard to updating, synchronizing and centrally scheduling content.

In an embodiment of the invention, user instrument 130 may belong to any owner. Any instrument 130 can be used for sending the OTP regardless of the owner of instrument 130 or whether communication unit 130 is registered with authentication unit 106 or not.

The user instrument 130 which may be a communication unit or mobile unit through which OTP along with other details are sent is not required to be registered to a particular server.

The system doesn't need a concurrent/synchronized processing device for pecuniary communication, hence reducing the cost of managing the system. System which generates different unique OTP's for each transaction ensures secure transaction.

The foregoing description of the invention has been set merely to illustrate the invention and is not intended to be limiting. Since, modifications of the disclosed embodiments incorporating the spirit and substance of the invention may occur to person skilled in the art, the invention should be construed to include everything within the scope of appended claims.

1. A method for processing a user request using at least one of a plurality of user instruments to conduct a pecuniary communication at a server with a merchant over a communications network, the method comprising:
receiving a first request from the user at the user instrument in order to generate an OTP;
receiving a second request at the server from the user, the second request includes the generated OTP, an user instrument details, a merchant ID, and the pecuniary particulars;
verifying the user based on the received OTP and the user instrument details in order to authenticate the user to conduct the pecuniary communication with the merchant;
verifying account information of the user stored at the server based on the pecuniary particulars;
verifying the merchant by the server using merchant ID; and
sending a confirmation message about success of the pecuniary communication to both the user and the merchant.

2. The method of claim 1 wherein the pecuniary communication is initiated without requiring a concurrent/synchronized device for processing.

3. The method of claim 1, further comprising registering a plurality of users and a plurality of merchants with the server to avail the services of secure pecuniary communications.

4. The method of claim 1, wherein generating the OTP is from the user instrument having an application configured for receiving a pin and generating a corresponding OTP.

5. The method of claim 1, wherein generating the OTP is from the user instrument like a card having a plurality of input keys and a LCD display.

6. The method of claim 1, wherein the step of receiving the second request is from the user instrument, where the user send the request including the generated OTP and the user instrument information to the server.

7. The method of claim 1, wherein the generated OTP is transmitted by different modes including text messaging, calling or using pre-existing application present in the user device.

8. The method of claim 1 wherein the confirmation message is sent by means of a text message to the user and the merchant by the server.

9. A system for processing a user request using at least one of a plurality of user instruments to conduct a pecuniary communication at a server with a merchant over a communications network, the system comprising:
the user instrument generating a onetime password OTP by processing a first request signal received from a user;
a server including a content management unit configured for receiving a second request, the second request includes the generated OTP, an user instrument details, a merchant ID, and the pecuniary particulars;
an authentication unit included in the content management unit for authenticating the user to conduct the pecuniary communication with the merchant by verifying the user based on the received OTP and the user instrument details; and
a verification unit included in the content management unit for verifying the merchant, verifying account information of the user stored at the server based on the pecuniary particulars and thereby enabling the server to send a confirmation message about the success of the pecuniary communication to both the user and the merchant.

10. The system as claimed in claim 9 wherein, the user instrument includes a cash card having a plurality of input keys and a Liquid Crystal Display (LCD) for displaying the OTP.

11. The system as claimed in claim 9 wherein, the user instrument includes a communication device like a mobile unit, PDA, tab, desktop, laptop or the like.

12. The system of claim 9 wherein the pecuniary communication is initiated without requiring a concurrent/synchronized device for processing.

13. The system as claimed in claim 9 wherein the content management unit enables pecuniary communication by managing communication from the authentication unit and the verification unit which function on different protocols.

14. The system as claimed in claim 9 wherein, the content management unit (CMU) includes information of the users.

15. The system as claimed in claim 9 wherein, the communication network is configured to interconnect various devices.

16. The system as claimed in claim 9 wherein, the communication network includes any number of wired and/or wireless networks including internet, intranet, local area networks, metropolitan networks, personal area networks, wide area networks, and direct connections.

17. The system as claimed in claim 9 wherein the content management unit is configured for verifying account information of the user with a pecuniary institution through a pecuniary settlement manager.
